(19) United States
(12) Patent Application Publication
(10) Pub. No.: US 2013/0075002 A1
(43) Pub. Date: Mar. 28, 2013

(54) SPLIT INNER TUBE

(71) Applicant: David GASTELUM, Riverside, CA (US)

(72) Inventor: David GASTELUM, Riverside, CA (US)

(21) Appl. No.: 13/493,822

(22) Filed: Jun. 11, 2012

Related U.S. Application Data
(60) Provisional application No. 61/538,380, filed on Sep. 23, 2011.
(60) Provisional application No. 61/620,271, filed on Apr. 4, 2012.

(51) Int. Cl. B60C 5/00; B23P 11/00

(52) U.S. Cl. 152/450; 29/894.3

(57) ABSTRACT

Improvements in an inner tube are presented. The inner tube is split at a location opposite of the valve stem. Locating the split at a location that is opposite of the valve allows the inner tube to be more balanced to prevent an out of balance inner tube that can result in making the bicycle unstable and less safe. A stiffener or snake may be incorporated to allow the inner tube to be pushed or pulled around the rim thereby making it easier to install the inner tube when access to the entire periphery of the rim. The free ends of the inner tube can have a connection mechanism that retains the ends in a secure or semi-secure arrangement. The Ideal mechanism may further provide a method of attracting and retaining the ends together to ensure that the inner tube creates and essentially complete circle.

### CROSS REFERENCE TO RELATED APPLICATIONS

This application claims the benefit of U.S. Provisional 61/538,380 filed Sep. 23, 2011 and U.S. Provisional 61/620,271 filed Apr. 13, 2012 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in an inner tube. More particularly, the present split inner tube is an inner tube that is not a complete circle. The split inner tube allows the inner tube to be inserted from one side of a rim and pushed around the rim to for a circular tube.

2. Description of Related Art Including Information Disclosed Under 37 CFR 1.97 and 1.98

Tires used on bicycles typically include an inner tube placed within the outer surface that makes contact with the ground and the hard rim that supports the inner tube and outer wearing surface. When an inner tube is punctured the outer tire is removed or offset and the inner tube replaced. A typical inner tube fabricated in a continuous torus shape with a single valve placed at some location along the torus. Installation of these torus shaped inner tubes is often difficult to install, especially when access to the entire circular diameter of the tire is not available. A number of patents have been issued that provide solutions to this problem. Exemplary examples of patents that have been issued that try to address this problem are identified and discussed below.

U.S. Pat. No. 911,041 issued Feb. 2, 1909 to E. J. Hinks and U.S. Pat. No. 503,560 issued Aug. 15, 1893 to G. F. Callaghan both disclose multiple segmented inner tubes. These inner tubes allow for one segment to be pierced and the remaining segments to remain filled with air. Just the pierced segment can be replaced or patched. While these patents disclose inner tube or inner tube segments, they are formed from multiple pieces and further require that the rim be fabricated with multiple holes to accept multiple valve stems.

U.S. Pat. No. 508,173 issued Nov. 7, 1893 to A. A. & H. C. Kupfer discloses an inner tube formed with two layered cavities. The two cavities include an inner and outer bladder. When the outer bladder is ruptured, the inner bladder can be separately filled with air to inflate the tire and allow a person to continue using the inner tube without requiring the inner tube(s) to be replaced.

U.S. Pat. No. 1,317,976 issued Oct. 7, 1919 to J. F. Hower discloses a butt end inner tube. This inner tube includes a locking connector where one end is inserted into the other end to hold the inner tube connection. In this patent, a double wall section is created where the two parts interconnect. The double walled section creates an additional amount of material that is not present at other places along the inner tube and causes an imbalance in the rotational mass of the tube that can be felt by the rider.

What is needed is an inner tube where the connection of the closed ends of the inner tube exists opposite the valve of the inner tube. The ends of the inner tube should also be balanced with the rotational mass of the valve and further have a connection mechanism that keeps the ends of the tube connected. The disclosed split inner tube in this application provides a solution to the above identified problems.

### BRIEF SUMMARY OF THE INVENTION

It is an object of the split inner tube for the inner tube to be split at a location that is opposite of the valve stem. Locating the split at a location that is opposite of the valve allows the inner tube to be more balanced to prevent an out of balance inner tube that can result in making the bicycle unstable and less safe.

It is an object of the split inner tube for the tube to be slit to allow insertion of the inner tube from only opening within the tire and rim. A stiffener may also be incorporated to allow the inner tube to be pushed or pulled around the rim thereby making it easier to install the inner tube when access to the entire periphery of the rim.

It is another object the split inner tube for the free ends of the inner tube to have a connection mechanism that retains the ends in a secure or semi-secure arrangement. The ideal mechanism may further provide a method of attracting and retaining the ends together to ensure that the inner tube creates and essentially complete circle.

It is another object the split inner tube for the free tapered ends of the inner tube to have a connection mechanism that provides polarized magnetic attraction to align and join the tapered ends. This ensures that the taped ends fully seat without the ends bunching or not being fully engaged.

It is still another object of the split inner tube for the inner tube to prevent air movement around the inside of the inner tube. Air movement around the inner tube causes frictional forces within the inner tube that result in heating of the air within the inner tube. The elevated temperature within the inner tube results in shortening the life of the inner tube and premature rupture.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of the split inner tube.

FIG. 2 shows a perspective view of the split inner tube with tapered ends.

FIG. 3 shows a perspective cross sectional view of a split inner tube inside a tire.

FIG. 4 shows a side view of a split inner tube with tapered ends inside a tire.

FIG. 5 shows a side view of the installation of a split inner tube being installed within and around a tire.

FIG. 6 shows a side view of the installation of a split inner tube with tapered ends being installed within and around a tire.

### DETAILED DESCRIPTION OF THE INVENTION

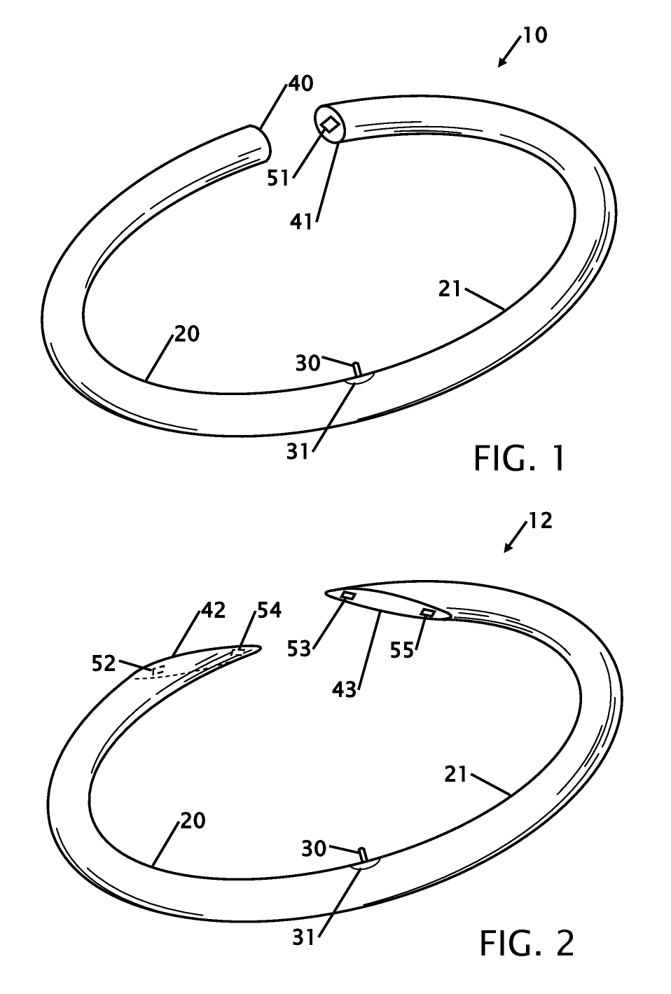

FIG. 1 shows a perspective view of the split inner tube 10. The split inner tube 10 is formed with end closures 40, 41 that maintain pressure within the tube 10. The inner tube is broken at a location distal or at the opposite side from a filling orifice 30. The tube arms 20, 21 extend approximately an equal distance from the filling orifice. The end closures 40 and 50 form a first and a second end and is fabricated to approximate the weight of the valve stem, orifice 30 and sealing connection 31. The wall thickness(es) of the end closures 40, 50 and the valve 30/sealing connection 31 are designed to offset any rotational imbalance to minimize vibration that is transmitted to the user when the wheel is rotating.

At the end of each arm 20, 21 of the inner tube 10 a connection mechanism 50 is included to maintain the ends of the inner tube in proximity to form a complete round or torus tube. While in this figure only one connection mechanism 51 is shown the opposing connection mechanism is shown and described in more detail in other figures.

FIG. 2 shows a perspective view of the split inner tube 12 with tapered ends 42 and 43. The tapered ends 42 and 43 produces a hard spot on the tire as the connection of the two ends rotates under the tire. Securely connecting the two ends together to ensure that they are properly aligned is with opposing polarity magnets 52 and 54 on one end 42 and with magnets 53 and 55 of the other tapered end 43. Because these magnets are opposing magnets 54 and 53 will repel each other along with magnets 51 and 55 repelling each other to prevent undesirable joining while magnets. Magnets 52 and 53 will attract each other and magnets 54 and 55 will attract to ensure correct alignment on the tapered faces of the split inner tube 12.

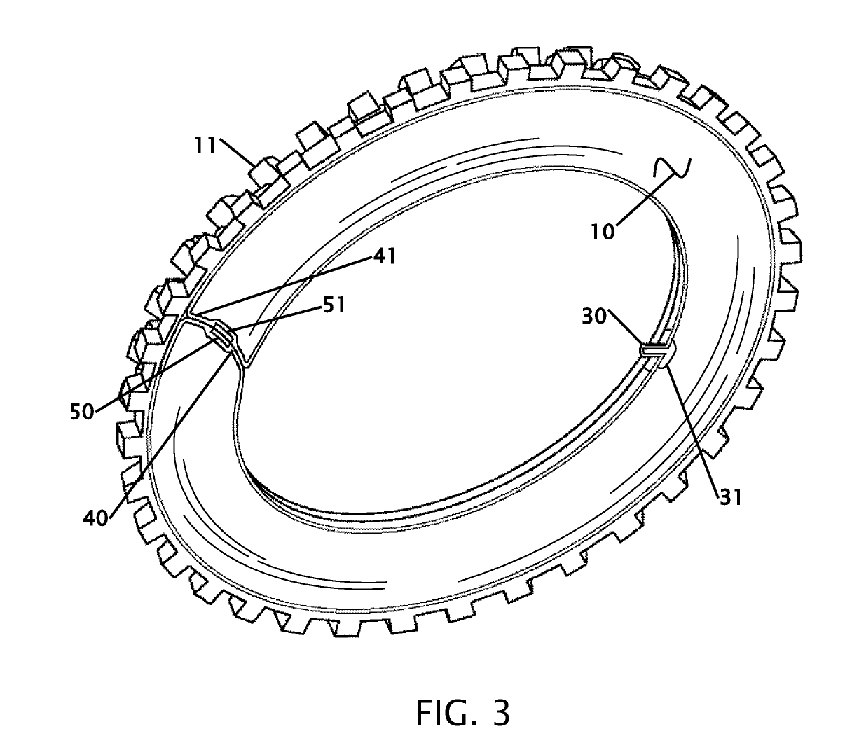

FIG. 3 shows a perspective cross sectional view of a split inner tube 10 inside a tire 11 where each of the arms 20 and 21 of the inner tube extend around the interior circumference of the tire 11. The valve stem 30 is placed through an opening in the rim to allow air to fill the inner tube or be vented from the inner tube 10. The valve sealing connection 31 provides a seal of the inner tube 10 to the rim of the tire. These figures show the inner tube with the ends 40 and 41 connected together. The connection can be a variety of type.

In one embodiment, the connection is with hook 50 and loop 51 fasteners. This type of fastening system provides a system that can be repeatedly connected and disconnected with variable amounts of force, based upon the type of hook and loop fasteners that are used. In another preferred embodiment the connection is with magnets 50 and 51. The magnets also allow the ends of the tube to be easily connected and separated. One advantage of using magnet(s) is the ability of the magnets to pull the ends of the tubes together and also for the magnets to self-center the first 40 and the second 50 arms or ends together to make a more perfect alignment of the inner tube 10 within the tire 11.

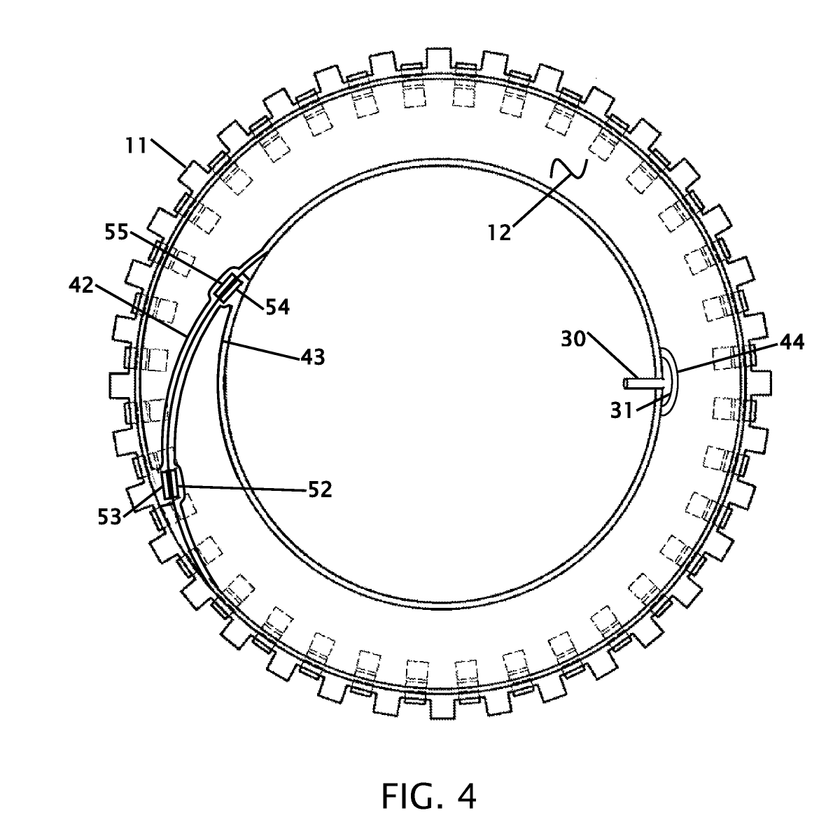

FIG. 4 shows a side view of a split inner tube 12 with tapered ends 42 and 43 inside a tire 11. As previously described with FIG. 2, magnets 52 is only attracted to magnet 53 and magnet 54 is only attracted to magnet 55. These magnets are further oriented far enough away from the rim to reduce a potential to magnetize the rim and also to prevent attraction of ferric materials to the side of the tire 11. It is further contemplated that the area 44 around the valve stem 30, 31 can be thickened to maintain a more proper balance of the tire to compensate for the additional mass of inner tube that is created by the tapered overlap.

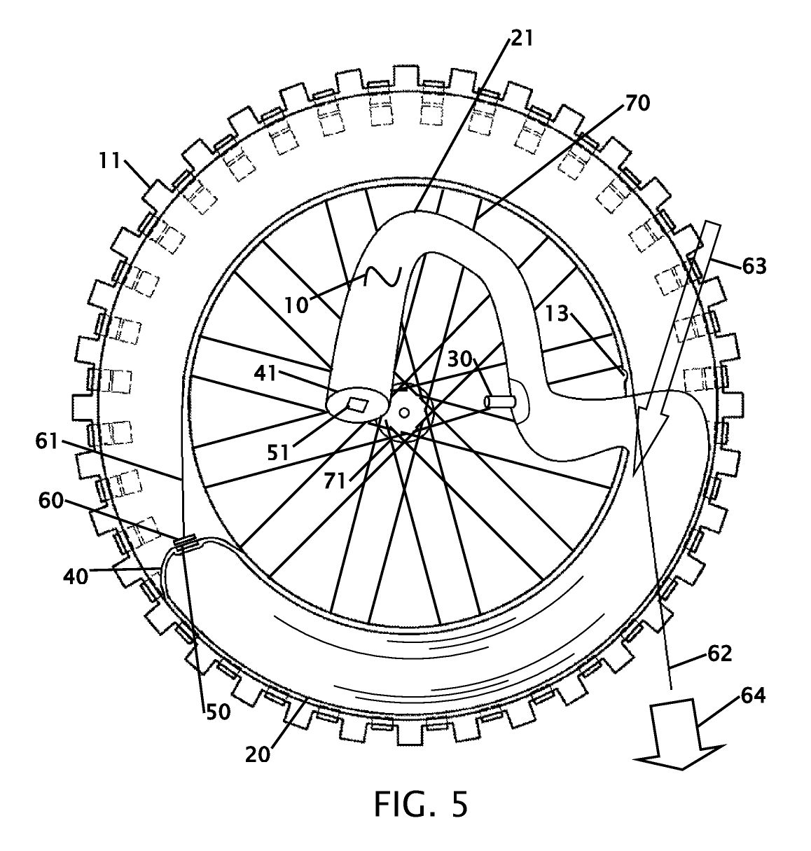

FIG. 5 shows a side view of the installation of a split inner tube 10 being installed within and around a tire 11. The tire assembly supports the tire 11 and inner tube 10 on a rim with a plurality of spokes 70 that connect at a hub 71. For a number of installations access to the circumference of the rim and tire is not available. For these installations the split inner tube 10 must be installed from a single location. To accomplish this task, a flexible fishing line or snake 61 that is made out of plastic, fiberglass or metal is inserted 63 between the tire 11 and the rim and then pushed around the inside of the rim and tire 11. The fishing line or snake 61 is then connected to one end or arm of the inner tube using hook and loop fasteners, magnets 50, 60 or other temporary connection mechanism. The free end 62 of the fishing line or snake 61 is pulled 64 until the valve stem 30 is aligned with the stem hole 13. Continued pulling of the line 62 will release the connection with the first end or arm 21.

The fishing line or snake 61 can then be passed the other direction through the tire 11 and then connected to the second free end or arm 41 where the fishing line or snake 61 is connected to the hook and loop fastener or magnet 51, 60. When the second arm 21 is pulled around the inside of the tire 11, additional pulling will release the connection between the fishing line or snake 61 and the connection mechanism 51 on the second arm. When magnets are used to on the arm ends the magnets will attract and align to form a complete circle.

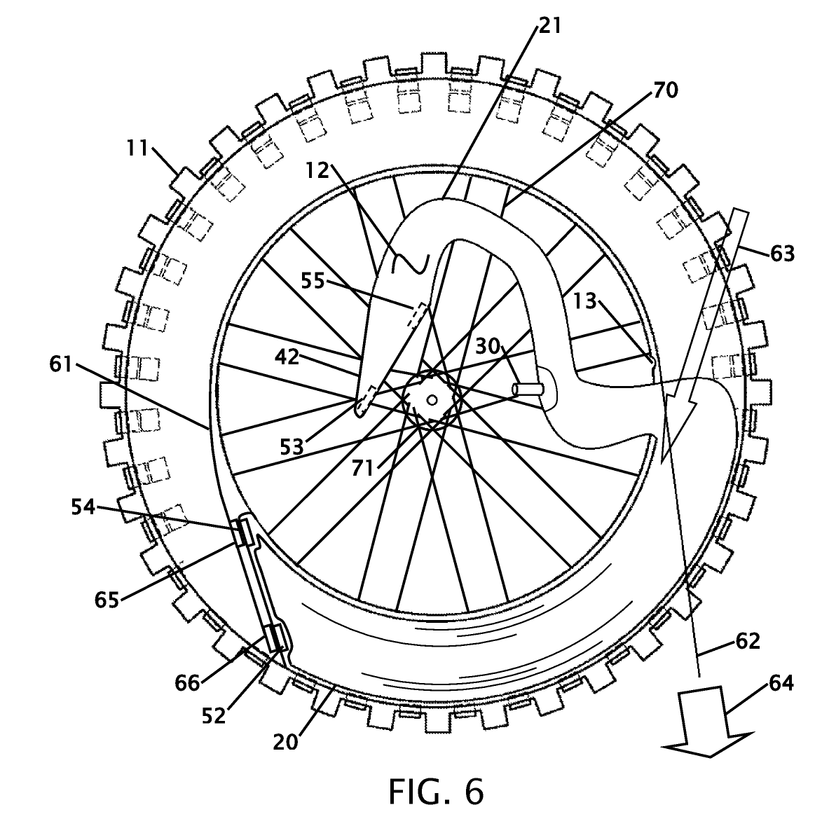

FIG. 6 shows a side view of the installation of a split inner tube 12 with tapered ends 42 and 43 being installed within and around a tire 11. The snake 61 in this embodiment has two sets of magnets 65 and 66 that attract to the respective magnets 52 and 54 to pull the inner tube 12 around within the rim.

Thus, specific embodiments of a split inner tube have been disclosed. It should be apparent, however, to those skilled in the art that many more modifications besides those described are possible without departing from the inventive concepts herein. The inventive subject matter, therefore, is not to be restricted except in the spirit of the appended claims.

1. A split inner tube comprising:
an inner tube that is broken at a location distal from a filling orifice wherein said broken location forms a first end and a second end of said inner tube;
said broken section is configured to be approximately the weight of said filling orifice, and
said first end and said second end further includes a connection mechanism to maintain said first end and said second end in proximity to each other.

2. The split inner tube according to claim 1 wherein said connection mechanism is with hook and loop fasteners.

3. The split inner tube according to claim 2 wherein that further includes a guiding mechanism that can be temporally secured to said first end or said second end to pull said inner tube through a tire.

4. The split inner tube according to claim 3 wherein said guiding mechanism is a flexible fishing line or snake.

5. The split inner tube according to claim 4 wherein said guiding mechanism is configured to extend at least completely around a rim.

6. The split inner tube according to claim 1 wherein said connection mechanism is with magnets.

7. The split inner tube according to claim 6 wherein said magnets are arranged in polarity to attract and engage said first end and a second end of said inner tube.

8. The split inner tube according to claim 6 wherein said magnets are arranged to reduce attraction of ferric material from beyond said inner tube.

9. The split inner tube according to claim 6 wherein that further includes a guiding mechanism that can be temporally secured to said first end or said second end to pull said inner tube through a tire.

10. The split inner tube according to claim 9 wherein said guiding mechanism is a flexible fishing line or snake.

11. The split inner tube according to claim 1 wherein said filling orifice is configured to approximate a mass of a combination of said first end, said second end and said connection mechanism.

12. The split inner tube according to claim 1 wherein said filling orifice further includes a filling valve stem.

13. The split inner tube according to claim 1 wherein said first end and said second end is tapered.

14. The split inner tube according to claim 13 wherein said connection mechanism is with at least two magnets in said first end and at least two magnets within said second end.

15. The split inner tube according to claim 13 wherein said taper is configured to nest said first and said second end to approximate the diameter of an inner tube section that is not tapered.

16. The split inner tube according to claim 14 wherein said magnets are arranged in polarity to attract, align and engage said first end and a second end of said inner tube.

17. The split inner tube according to claim 16 wherein that further includes a guiding mechanism with at least two magnets that can be temporally secured to said first end or said second end to pull said inner tube around a rim.

18. The split inner tube according to claim 1 that is configured for use with a bicycle, motor powered vehicle, utility vehicle or transportation vehicle.

19. The split inner tube according to claim 1 that further includes a method of installing said split inner tube comprising:
extending said first end around a rim;
extending said second end around an opposite end of said rim;
engaging said connection mechanism to maintain said first end and said second end in proximity to each other, and
aligning and inserting said filling orifice within an accommodating opening within said rim.

20. The split inner tube according to claim 1 wherein said split inner tube is predominantly round in cross-section.
